(19) United States
(12) Patent Application Publication
(10) Pub. No.: US 2015/0022884 A1
(43) Pub. Date: Jan. 22, 2015

(54) Sextant telescope with a zoom feature

(71) Applicant: Peter Hakel, Los Alamos, NM (US)

(72) Inventor: Peter Hakel, Los Alamos, NM (US)

(21) Appl. No.: 13/947,042

(22) Filed: Jul. 20, 2013

(51) Int. Cl. G02B 23/00

(52) U.S. Cl. CPC G02B 23/145
USPC 359/422

(57) ABSTRACT

Sextant telescope with a zoom feature is a device in which one of two available magnification settings is selected by repositioning an internal lens between two mutually conjugate locations. An optional reticle of a specialized pattern helps the proper alignment of the observed horizon and celestial bodies in the field of view of the telescope for easier and more accurate measurements; the placement of the reticle in the first focal plane ensures proper scaling of its apparent size with telescope magnification.

### CROSS-REFERENCE TO RELATED APPLICATIONS

N/A

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM, LISTING COMPACT DISC APPENDIX

N/A

### BACKGROUND AND OPERATION OF THE INVENTION

Celestial navigation is a collection of traditional mathematics and geometry methods for establishing and tracking the positions of vessels at sea based on astronomical observations. Even today in the age of the Global Positioning System (GPS) celestial navigation continues to be of interest to mariners and enthusiasts. At the core of celestial navigation procedures is the nautical sextant—a handheld instrument that is typically used to measure the angular separation (altitude) between the chosen celestial body and sea horizon.

Sextants are usually equipped with small, low-powered (magnification M<10) telescopes that help increase the accuracy of altitude measurements. The magnification powers commonly used in most recent sextant telescopes fall into two categories ([1], p. 125; [2], p. 103): 1) the lower-power M=3−4 (“star scope”), and, 2) the higher-power M=6−8 (“sun scope”). The former option is common for the observation of stars and planets. The latter one is relevant for the observations of the sun and the moon, whose apparent size (about half a degree in diameter) can be usefully magnified to increase the accuracy of the measurement. Traditionally, the change in magnification has been accomplished either by switching eyepieces in the telescope, or mounting an altogether different telescope onto the sextant. The design presented in this application allows the user to switch between the two magnifications by a simple repositioning of an internal lens, i.e., without having to change the telescope or the eyepiece. Since a lower magnification correlates with having a larger field of view, the user may use the star-scope mode to locate the object of interest, switch to the sun-scope mode (without having to take the eye off the target observed through the telescope), and use this higher magnification setting to refine the sextant measurement.

I am not aware of any prior art in which the mechanical and optical principles described in this application have been applied to the design of a telescope used in conjunction with a nautical sextant.

### BRIEF SUMMARY OF THE INVENTION

FIG. 1 shows the idealized (i.e., in the paraxial, thin-lens approximation) arrangement of the main optical components. The formation of the image is illustrated by the sequence of principal rays running through the telescope. The description of a working prototype (that, more realistically, uses compound lenses to control the various optical aberrations) is given in a later section of this document.

The object of observation is located at infinity and hence all incoming rays are parallel to each other. According to FIG. 1, objective lens A (focal length f_{A}=IACI) forms a real inverted image B of the object in the telescope's first focal plane C. Image-erecting zoom lens D forms a real erect image E in the telescope's second focal plane F. After crossing eyepiece G (focal length f_{G}=IFGI) the rays are once again parallel, forming an erect image located at infinity, and whose apparent angular size is magnified M times relative to the object itself. Eyepiece G can typically be moved around a little in order to allow the user to focus the image.

If objective lens A and eyepiece G alone were to be used to construct a telescope, the resulting image would be inverted with “reference” magnification M₀=f_{A}/f_{G}. The additional internal lens D has two functions: 1) it erects the image (a property that is convenient, albeit not required, in a sextant telescope), and 2) it changes the overall magnification of the telescope as the user slides lens D between the two mutually conjugate positions depicted in FIGS. 1a and 1b. For a given value of the “zoom factor” z (z>1, chosen by the telescope's designer) the two operating magnifications are Mₐ=M₀/z (the smaller value; the star-scope mode) and M_{b}=M₀×z (the larger value; the sun-scope mode). To that effect, lens D is mounted on shuttle H (see FIGS. 2 and 3) that can slide inside the main telescope tube between the two conjugate positions. Shuttle H is self-locked in position via friction, so that it can be easily moved by the user but will otherwise stay put. The final image is only in focus when lens D is in one of those two operating locations. This design called bang-bang zoom ([3], p. 330) keeps the telescope mechanically simple and inexpensive to make.

### BRIEF DESCRIPTION OF THE DRAWINGS AND PHOTOGRAPHS

FIG. 1a. Optical path schematic in the thin-lens approximation (star-scope mode)

FIG. 1b. Optical path schematic in the thin-lens approximation (sun-scope mode)

FIG. 2a. Partially assembled prototype (star-scope mode)

FIG. 2b. Partially assembled prototype (sun-scope mode)

FIG. 3a. Fully assembled prototype (star-scope mode)

FIG. 3b. Fully assembled prototype (sun-scope mode)

FIG. 4a. The pattern of an optional reticle in the first focal plane C

FIG. 4b. The pattern of an optional reticle with captions and dimensions

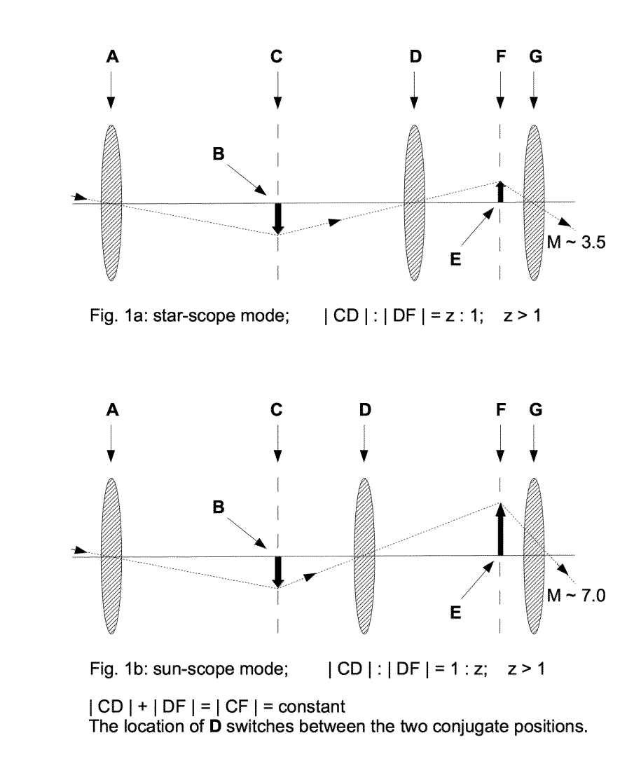

### DETAILED DESCRIPTION OF A PROTOTYPE

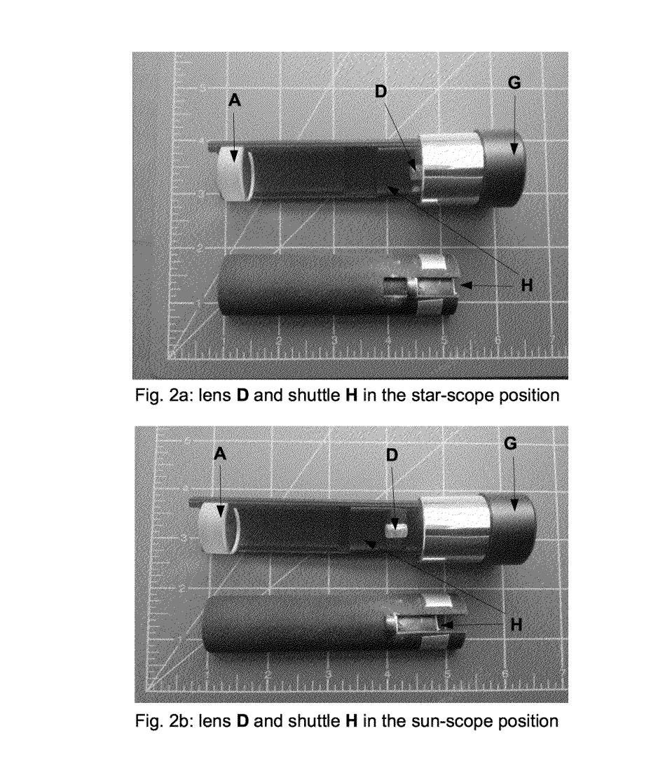

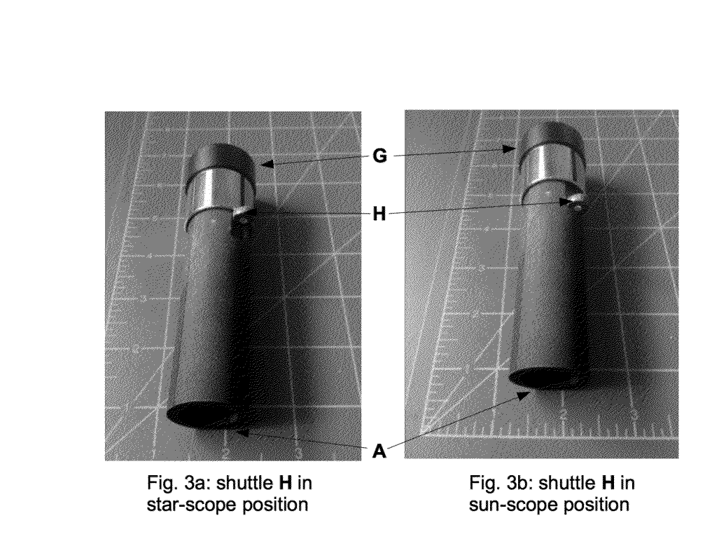

Photographs of a prototype are in FIGS. 2 and 3.
Objective lens A: achromatic doublet lens, diameter 25 mm, effective focal length f_{A}=50 mm, origin: Edmund Optics Inc. stock lens No. NT32-323. (An aspherized achromatic lens is also possible here in order to further improve image quality.)
Zooming erector D: Steinheil triplet achromat lens, diameter 6.25 mm, effective focal length f_{D}=12.5 mm, origin: Edmund Optics Inc. stock lens No. NT47-673. This lens was chosen in accordance with the symmetrical principle ([3], p. 417 and p. 680) applicable to relay systems working at or near unit magnification (see below for the choice of the value of the zoom factor z˜1.41 in this prototype). (A Hastings triplet achromat lens is also a possibility here. [3], p. 463)
Eyepiece G: 1.25″ Piössl telescope eyepiece, effective focal length f_{G}=10 mm, origin: TwinStar (via Amazon.com). (Many different extant eyepiece types, e.g. Huygenian, Ramsden, Kellner, Nagl, Erfle, etc., could also be used here. [3], p. 459)
Reference magnification: M₀=f_{A}/f_{G}=5
Zoom factor: z=square root of 2˜1.41
Lower-magnification (star-scope mode): Mₐ=5/1.41˜3.5
Higher-magnification (sun-scope mode): M_{b}=5×1.41˜7.0
I used the Trimble SketchUp design software to draft the two halves of both the main telescope tube and shuttle H. These parts were then manufactured using 3-D printing technology by Shapeways Inc., based on STL (STereoLithography or Standard Tessellation Language) files exported from SketchUp.

Optional Add-Ons

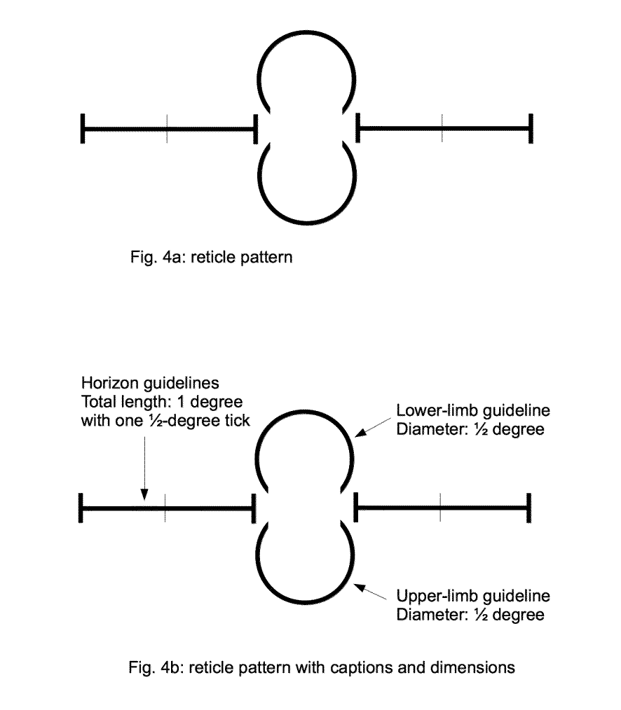

This telescope design has internal focal planes, which allows for the insertion of a reticle that can aid the operation of the telescope for its main intended purpose. The reticle could be inscribed on a thin transparent piece of material (possibly curved to compensate for the Petzval curvature of the objective lens A ([3], p. 671). This element would be inserted into the first focal plane C, so that the apparent size of the reticle pattern can scale with the chosen magnification mode. The proposed pattern is displayed in FIG. 4a whereas FIG. 4b shows the angular dimensions of the parts of the pattern. The physical dimensions “d” of the reticle's parts are related to their angular sizes “a” by d=f_{A}×tan (a), where f_{A} is the objective focal length. For example, in our prototype (f_{A}=50 mm) the diameters of the circles (a=0.5°) would be d˜0.44 mm. The horizon guidelines aid the user in keeping the sextant frame perpendicular to the horizon without having to swing the arc ([2], p. 117). The circles help with the placing of the sun or the moon disc on the horizon for the altitude measurement. Both circles can be simultaneously employed in the sun's lunar-distance observations ([2], p. 81). The known angular distances marked by the reticle's parts can also aid the user in estimating the distances to objects of known size. The reticle can be internally illuminated to help with sights taken during twilight.

Annular baffles can be inserted between objective A and the first focal plane C in order to reduce glare due to internal reflections of stray rays [4].

I claim:

1. A sextant telescope with a zoom feature, in which a change in magnification is effected by the sliding of an internal lens between two mutually conjugate locations.)

2. A reticle pattern depicted in FIG. 4 located in the telescope's first focal plane.
